(19) United States
(12) Patent Application Publication
(10) Pub. No.: US 2020/0334029 A1
(43) Pub. Date: Oct. 22, 2020

(54) UPDATE SYSTEM

(71) Applicant: FANUC CORPORATION, Yamanashi (JP)

(72) Inventors: Masatoshi NAKAJIMA, Yamanashi (JP); Masaaki SHINDOU, Yamanashi (JP)

(73) Assignee: FANUC CORPORATION, Yamanashi (JP)

(21) Appl. No.: 16/845,934

(22) Filed: Apr. 10, 2020

(30) Foreign Application Priority Data
Apr. 16, 2019 (JP) 2019-077968

(51) Int. Cl. G06F 8/65

(52) U.S. Cl. CPC G06F 8/65

(57) ABSTRACT

The disclosure is intended to provide an update system allowing software to be updated in an easier way. An update system updates software set in a numerical controller to new software. The update system includes: a device specific information acquisition unit that acquires specific information retained by the numerical controller as device specific information from the numerical controller; a candidate extraction unit that extracts candidates of software for update on the basis of the acquired device specific information; a software selection unit that selects the new software to be set in the numerical controller from the extracted candidates of software for update; and an update execution unit that executes setting of the selected new software in the numerical controller.

This application is based on and claims the benefit of priority from Japanese Patent Application No. 2019-077968, filed on 16 Apr. 2019, the content of which is incorporated herein by reference.

### BACKGROUND OF THE INVENTION

### Field of the Invention

The present invention relates to an update system.

### Related Art

The operations of industrial machines including industrial robots, machine tools, etc. have conventionally been performed on the basis of signals from numerical controllers (NC). As an example, the numerical controller is incorporated into the industrial machine and provided together with the industrial machine. A control program (hereinafter also called software) to be set in the controller is preinstalled at the time of manufacture of the industrial machine and provided together with the industrial machine.

The software to be set in the numerical controller is preferably updated to new software to be more suited for a request from a destination of shipment, an environment of installation, modification of the program, etc. As an example, means of updating software through a network has been suggested (see patent document 1, for example).
Patent Document 1: Japanese Unexamined Patent Application, Publication No. 2007-102625

### SUMMARY OF THE INVENTION

In some cases, the numerical controller is equipped with a function specific to each controller. Simply updating the software might affect the specific function already prepared. In the other hand, if the software already set is highly reliable, introducing new software without careful consideration is undesirable in some cases. Setting of the new software has become complicated for such reasons. Hence, it will be preferred if software can be updated in an easier way.

(1) One aspect of the disclosure is an update system that updates software set in a numerical controller to new software. The update system includes: a device specific information acquisition unit that acquires specific information retained by the numerical controller as device specific information from the numerical controller; a candidate extraction unit that extracts candidates of software for update on the basis of the acquired device specific information; a software selection unit that selects the new software to be set in the numerical controller from the extracted candidates of software for update; and an update execution unit that executes setting of the selected new software in the numerical controller.

According to the one aspect, software can be updated in an easier way.

### BRIEF DESCRIPTION OF THE DRAWINGS

FIG. 1 is a schematic view showing an overall configuration of an update system according to one embodiment;

FIG. 2 is a block diagram of an updating terminal in the update system of the one embodiment;

FIG. 3 is a block diagram of a management server in the update system of the one embodiment;

FIG. 4 is a flowchart showing the operation of the update system of the one embodiment;

FIG. 5 is a flowchart showing a flow of deciding new software in the update system of the one embodiment; and

FIG. 6 is a screen view showing a screen for selecting new software in the update system of the one embodiment.

### DETAILED DESCRIPTION OF THE INVENTION

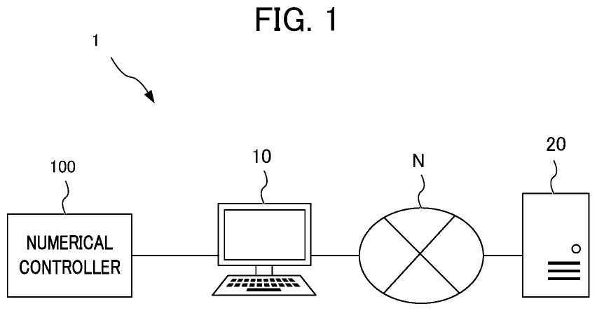

An update system 1 according to one embodiment of the disclosure will be described below by referring to FIGS. 1 to 6. Before description of the update system 1 of the embodiment, description will be given about a numerical controller 100 in which software updated by the update system 1 is set. The numerical controller 100 is a device that controls the operations of industrial machines (not shown) including industrial robots, machine tools, etc. The numerical controller 100 operates the industrial machines in response to software set in the numerical controller 100. In addition to general software, software corresponding to an extension specific to the numerical controller 100 (hereinafter also called an extension) is set in the numerical controller 100. The numerical controller 100 operates the industrial machines by fulfilling the extension while executing the general software, for example.

The update system 1 of the embodiment is a system that updates software set in the numerical controller 100 to new software. The update system 1 is a system capable of selecting new software from candidates of software available for update and using the selected software for update on the basis of the general software and the extension set in the numerical controller 100. As shown in FIG. 1, the update system 1 includes an updating terminal 10 and a management server 20.

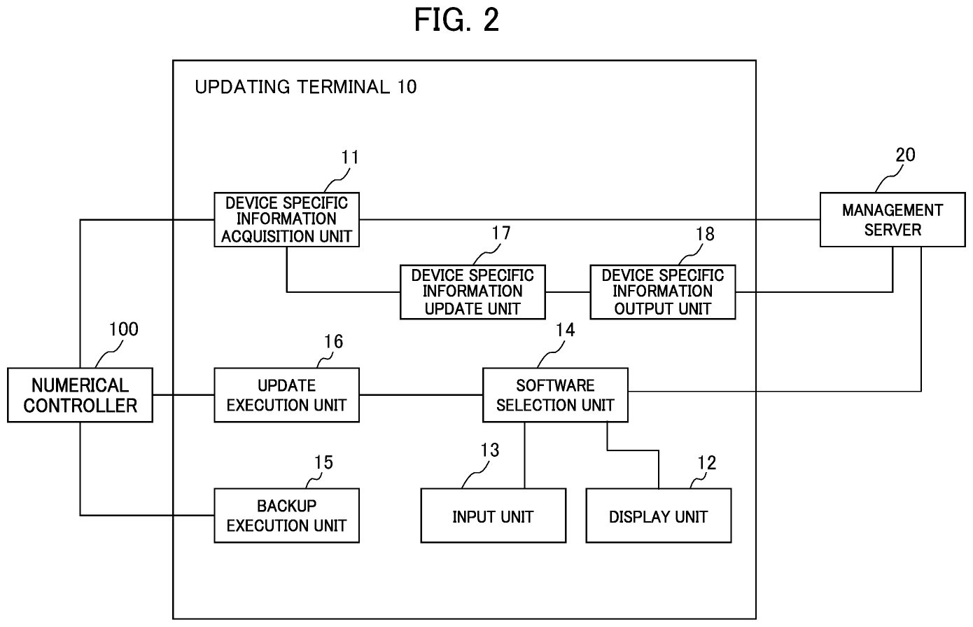

For example, the updating terminal 10 is a non-portable terminal such as a desktop personal computer or a portable terminal such as a notebook personal computer. As shown in FIG. 2, the updating terminal 10 includes a device specific information acquisition unit 11, a display unit 12, an input unit 13, a software selection unit 14, a backup execution unit 15, an update execution unit 16, a device specific information update unit 17, and a device specific information output unit 18.

The device specific information acquisition unit 11 is realized by the operation of a CPU, for example. The device specific information acquisition unit 11 acquires device specific information from the numerical controller 100. The device specific information is identification information for identifying the numerical controller 100, the system (type) and version of general software, and an extension set in the numerical controller 100, for example. The device specific information acquisition unit 11 transmits the acquired device specific information to the management server 20.

The display unit 12 is a display device such as a liquid crystal display, for example. The display unit 12 is configured to allow display of various types of information.

The input unit 13 is an input device including a keyboard and a mouse, for example. The input unit 13 accepts input of a worker to execute update.

The software selection unit 14 is realized by the operation of the CPU, for example. The software selection unit 14 selects new software to be set in the numerical controller 100 from candidates (list) of software for update extracted by the management server 20. The software selection unit 14 causes the display unit 12 to display the list of software pieces. The software selection unit 14 accepts selection of software for update at the input unit 13. The new program is a correction program for correcting the general software, a program for adding a new extension, or a program for updating the general software, for example.

The backup execution unit 15 is realized by the operation of the CPU, for example. The backup execution unit 15 acquires information about software set in the numerical controller 100 so as to allow restoration of software already set in the numerical controller 100 to its initial state after the software is updated.

The update execution unit 16 is realized by the operation of the CPU, for example. The update execution unit 16 executes setting of the selected new software in the numerical controller 100. For example, the update execution unit 16 acquires an execution file for update to the selected new software from the management server 20. The update execution unit 16 executes the acquired execution file to set the new software in the numerical controller 100.

The device specific information update unit 17 is realized by the operation of the CPU, for example. The device specific information update unit 17 updates the device specific information on the basis of setting of the new software executed by the update execution unit 16. For example, the device specific information update unit 17 updates device specific information already acquired to device specific information including information about the new software.

The device specific information output unit 18 is realized by the operation of the CPU, for example. The device specific information output unit 18 outputs the updated device specific information. More specifically, the device specific information output unit 18 outputs the updated device specific information to the management server 20.

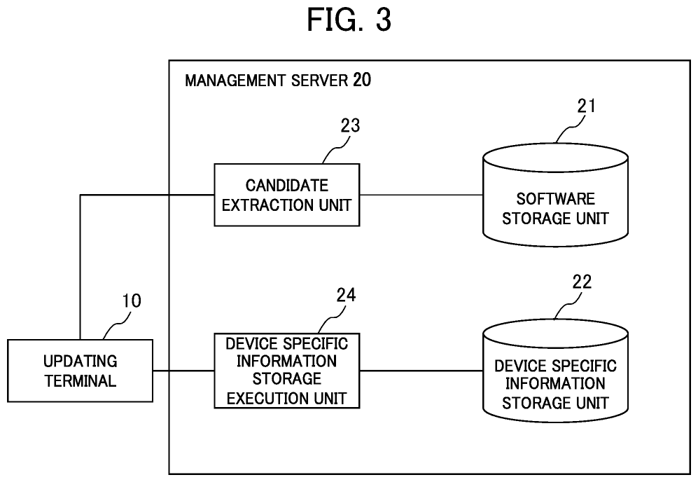

The management server 20 is connected to the updating terminal 10 through a telecommunication line N (the Internet). The management server 20 is connected using an Internet connection, for example. As shown in FIG. 3, the management server 20 includes a software storage unit 21, a device specific information storage unit 22, a candidate extraction unit 23, and a device specific information storage execution unit 24.

The software storage unit 21 is an auxiliary storage device such as a hard disk, for example. The software storage unit 21 stores software of various versions, a modification program, and a program for an extension.

The device specific information storage unit 22 is an auxiliary storage device such as a hard disk, for example. The device specific information storage unit 22 stores device specific information about the numerical controller 100.

The candidate extraction unit 23 is realized by the operation of a CPU, for example. The candidate extraction unit 23 extracts candidates of software for update on the basis of acquired device specific information. For example, the candidate extraction unit 23 extracts software pieces available for update from software pieces stored in the software storage unit 21. The candidate extraction unit 23 generates a list of the extracted candidates and transmits the generated list to the software selection unit 14. Further, the candidate extraction unit 23 acquires a program from the software storage unit 21 corresponding to software selected by the software selection unit 14. The candidate extraction unit 23 transmits the acquired program to the update execution unit 16.

The device specific information storage execution unit 24 is realized by the operation of the CPU, for example. The device specific information storage execution unit 24 stores the updated device specific information output from the device specific information output unit 18 into the device specific information storage unit 22.

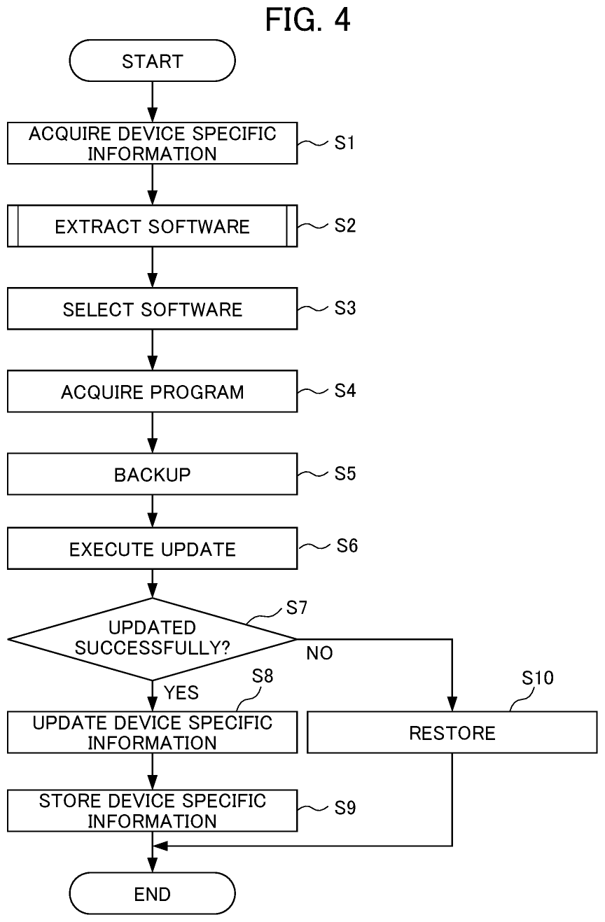

The operation of the update system 1 will be described next using the flowchart in FIG. 4. First, as shown in FIG. 4, the updating terminal 10 is connected to the numerical controller 100. The device specific information acquisition unit 11 acquires device specific information from the numerical controller 100 (step S1). The device specific information acquisition unit 11 transmits the acquired device specific information to the management server 20.

Next, the candidate extraction unit 23 extracts software pieces available for update on the basis of the device specific information (step S2). The candidate extraction unit 23 transmits a list of the extracted software pieces to the software selection unit 14. A flow of extracting the software pieces available for update will be described in detail later.

Next, the software selection unit 14 displays the list of the software pieces on the display unit 12. Further, the software selection unit 14 accepts input from a worker selecting updating software through the input unit 13 (step S3). The software selection unit 14 selects the updating software having been selected in the accepted input.

The candidate extraction unit 23 acquires a program for the selected software from the software storage unit 21 (step S4). The candidate extraction unit 23 transmits the acquired program to the update execution unit 16.

Next, the backup execution unit 15 acquires information about software set in the numerical controller 100 (step S5). The backup execution unit 15 retains the acquired information about the software.

Next, the update execution unit 16 executes setting of the selected new software in the numerical controller 100 (step S6). For example, the update execution unit 16 sets the program acquired from the candidate extraction unit 23 in the numerical controller 100.

Next, success or failure of the update is determined (step S7). If the update has been executed successfully (step S7: YES), the process proceeds to step S8. By contrast, if the update has ended in failure (step S7: NO), the process proceeds to step S10.

In step S8, the device specific information update unit 17 updates the device specific information. The device specific information update unit 17 transmits the updated device specific information to the device specific information output unit 18. The device specific information output unit 18 outputs the device specific information to the device specific information storage execution unit 24. The device specific information storage execution unit 24 stores the device specific information into the device specific information storage unit 22 (step S9).

In step S10, the backup execution unit 15 restores the software set in the numerical controller 100. In this way, the backup execution unit 15 restores the software set in the numerical controller 100 to a state before the update. Then, the update process is finished.

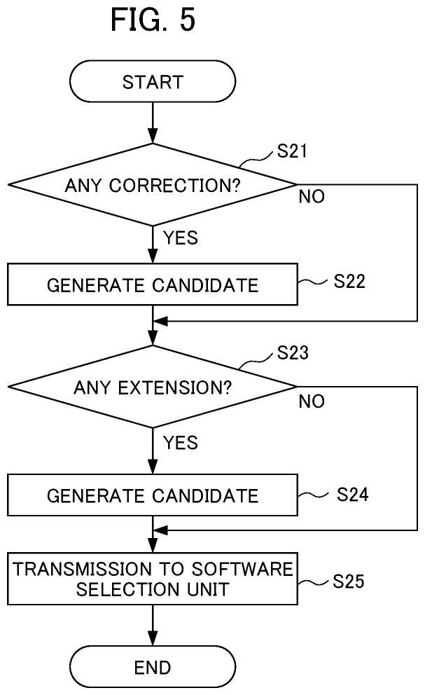

Next, a flow of extracting software for update will be described using the flowchart in FIG. 5. First, the candidate extraction unit 23 determines the presence or absence of an update program or a correction program (new program) for general software and an extension already set (software being set) (step S21). In the presence of a new program (step S21: YES), the process proceeds to step S22. By contrast, in the absence of a new program (step S21: NO), the process proceeds to step S23. In step S22, a list of new programs for the software being set is generated.

Next, in step S23, the candidate extraction unit 23 determines the presence or absence of a newly settable extension. In the presence of a new extension (step S23: YES), the process proceeds to step S24. By contrast, in the absence of a new extension (step S23: NO), the process proceeds to step S25. In step S24, the candidate extraction unit 23 generates a list of new extensions.

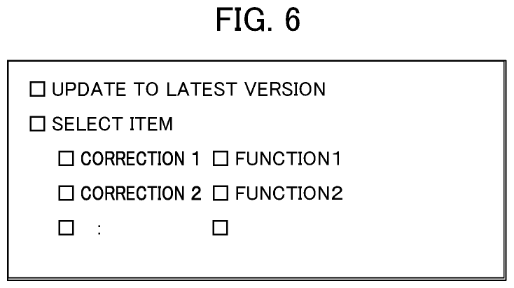

Next, in step S25, the candidate extraction unit 23 transmits the generated list to the software selection unit 14. The software selection unit 14 displays the received list on the display unit 12, as shown in FIG. 6.

The update system 1 according to the embodiment described above attains the following effects.

(1) The update system 1 includes: the device specific information acquisition unit 11 that acquires specific information retained by the numerical controller 100 as device specific information from the numerical controller 100; the candidate extraction unit 23 that extracts candidates of software for update on the basis of the acquired device specific information; the software selection unit 14 that selects new software to be set in the numerical controller 100 from the extracted candidates of software for update; and the update execution unit 16 that executes setting of the selected new software in the numerical controller 100. Thus, new software pieces available for update can be displayed for each numerical controller 100. Then, software to be set can be selected from the software pieces being displayed. As a result, software can be updated in an easier way independently of a situation of setting in the numerical controller 100.

(2) The device specific information acquisition unit 11 acquires a version of software set in the numerical controller 100 as system information, and the candidate extraction unit 23 extracts software of a newer version as a candidate of software for update. Thus, software can be updated in an easy way in the presence of software of a new version.

(3) The device specific information acquisition unit 11 acquires an extension of software set in the numerical controller 100 as system information, and the candidate extraction unit 23 extracts another extension as a candidate of software for update. Thus, software can be updated in an easy way in the presence of another extension.

(4) The update system 1 further includes: the device specific information update unit 17 that updates the device specific information on the basis of the setting of the new software executed by the update execution unit 16; and the device specific information output unit 18 that outputs the updated device specific information. This allows the updated device specific information to be managed externally. As a result, a situation of setting of software in the numerical controller 100 can be checked from outside without the need of acquiring device specific information directly from the numerical controller 100.

(5) The update system 1 further includes the device specific information storage unit 22 that stores the device specific information output from the device specific information output unit 18. This makes it possible to determine the presence or absence of software for update without the need of acquiring device specific information from the numerical controller 100.

While the preferred embodiment of the update system of the disclosure has been described above, the disclosure is not limited to the foregoing embodiment but can be changed appropriately.

As an example, while the update system 1 described in the foregoing embodiment includes the updating terminal 10 and the management server 20, the disclosure is not limited to this example. The update system 1 may include an additional terminal, for example. The structures of the updating terminal 10 and those of the management server 20 are given as examples and are required only to be provided in either the updating terminal 10 or the management server 20.

According to the description of the foregoing embodiment, the candidate extraction unit 23 extracts software pieces available for update on the basis of device specific information. The candidate extraction unit 23 can exclude software available for update but not suitable for update from candidates. In some cases, for example, an extension already set in the numerical controller 100 becomes inoperable or the operation of such an extension is not guaranteed under a new version of general software. In such cases, the candidate extraction unit 23 can exclude the new version of the general software from the candidates. More specifically, the candidate extraction unit 23 can avoid transmission of the new version of the general software to the software selection unit 14. This makes it possible to reduce the probability of setting of software not suitable for update in the numerical controller 100. This can reduce the occurrence of a trouble to be caused by setting of new software in the numerical controller 100.

### EXPLANATION OF REFERENCE NUMERALS

1 Update system
10 Updating terminal
11 Device specific information acquisition unit
14 Software selection unit
16 Update execution unit
17 Device specific information update unit
18 Device specific information output unit
20 Management server
22 Device specific information storage unit
23 Candidate extraction unit
100 Numerical controller

What is claimed is:

1. An update system that updates software set in a numerical controller to new software, comprising:
a device specific information acquisition unit that acquires specific information retained by the numerical controller as device specific information from the numerical controller;
a candidate extraction unit that extracts candidates of software for update on the basis of the acquired device specific information;
a software selection unit that selects the new software to be set in the numerical controller from the extracted candidates of software for update; and
an update execution unit that executes setting of the selected new software in the numerical controller.

2. The update system according to claim 1, wherein the device specific information acquisition unit acquires a version of the software set in the numerical controller as system information, and
the candidate extraction unit extracts software of a newer version as a candidate of software for update.

3. The update system according to claim 1, wherein the device specific information acquisition unit acquires an extension of the software set in the numerical controller as system information, and
the candidate extraction unit extracts another extension as a candidate of software for update.

4. The update system according to claim 1, further comprising:
a device specific information update unit that updates the device specific information on the basis of the setting of the new software executed by the update execution unit; and
a device specific information output unit that outputs the updated device specific information.

5. The update system according to claim 4, further comprising:
a device specific information storage unit that stores the device specific information output from the device specific information output unit.
